(19) United States
(12) Patent Application Publication
(10) Pub. No.: US 2003/0128891 A1
(43) Pub. Date: Jul. 10, 2003

(54) Forensic microscopy system

(76) Inventors: Rex Hoover, Sumerduck, VA (US); Robert G. Hoover, Sumerduck, VA (US)

Correspondence Address: PARENT PATENT RESEARCH, INC, 600 NORTH PICKETT STREET, ALEXANDRIA, VA, 22304

(21) Appl. No.: 09/805,142

(22) Filed: Mar. 14, 2001

(51) Int. Cl. G06K 9/36

(52) U.S. Cl. 382/284

(57) ABSTRACT

A forensic microscopy system is disclosed wherein a plurality of panoramic views of the sides of a spent bullet or casing may be stored in a computer. To compare one of these stored images with a sample bullet or casing, a computer controlled stepping motor rotates the sample approximately five degrees and an image is taken and stored at each stop. After the full 360 degrees has been accumulated, the images are formed together to create a single whole picture of the entire circumferential surface of the sample. This panoramic strip is then split longitudinally into two halves. The same is done with the stored sample and the “right side” and “left side” of both the strips are matched with their opposite side of the corresponding sample. The software in the computer then allows the user to compare the pattern of lands and grooves on the sample with another stored sample pattern by putting the two images side by side and allowing the user to move one of them in relation to the other. Bullets fired from the same weapon are easily and quickly matched visually. Additionally, the sample bullet or casing can be compared sequentially with any number of other stored sample images.

### BACKGROUND OF THE INVENTION

1. Field of the Invention

The present invention relates generally to microscopy. More specifically, it relates to a system that uses a combination of microscopy and digital image processing to compare two separate objects for physical similarities. Even more specifically, the present invention relates to a system that may be used to create a panoramic or continuous view of the outer surface of a bullet or casing and that allows the user to then visually compare the disparate images to determine whether the sample thus examined was fired out of or are from the same gun. Additionally, the present invention could be used to create a digital database over a network that would allow a state or organization to keep on file the land/groove configuration of registered firearms so that if a crime is committed involving a spent bullet, a search can be conducted through the sampled, fired bullets on file. More generally, the apparatus could be used for quality control comparison, or the like, taking a sample from a production run and comparing it with a digitally stored template image.

2. Description of the Prior Art

In the field of forensic science, one of the most important tasks in investigating crimes involving firearms is the ballistic comparison test used to determine if a certain gun fired a certain bullet. This is done by comparing the lands and grooves on a bullet fired from the gun in question or a casing ejected from the gun in question. This is a painstaking task that often requires the use of highly specialized equipment. The present invention seeks to simplify the task while giving a less complex (and thus less expensive) alternative to the existing machines adapted to this purpose. The present invention also allows for a large number of digitized samples to be stored in the machine and shared out over a network.

During a search at the U.S. Patent and Trademark Office, a number of relevant patents were uncovered and they will be discussed below.

U.S. Pat. No. 3,780,614 issued to Howard A. Maier on Dec. 25, 1973 discloses a bullet and cartridge mount for a microscope. This is clearly unlike the present invention as no computer controlled motors are taught.

In U.S. Pat. No. 4,334,241 issued on Jun. 8, 1982 to Seiji Kashioka et al. there is disclosed a pattern position detection system. Unlike the present invention, there is no teaching the controlled stepping to assemble the compound image for comparison.

An automatic key identification system is disclosed in U.S. Pat. No. 4,899,391 issued to William J. Cimino on Feb. 6, 1990. In this patent the computer compares a digitized image to a number of stored key blank images and indicates the proper blank to be used in copying the key. This is clearly dissimilar from the present invention.

Next is U.S. Pat. No. 4,933,976 issued to Brian H. Fishbine et al. on Jun. 12, 1990. This is a system for generating rolled images of fingerprints. Unlike the present invention, there again is no teaching of the stepped acquired image used in the instant invention.

Another patent that was found to be of interest is U.S. Pat. No. 5,177,792 issued on Jan. 5, 1993 to Kochira Morita. This is an apparatus for the high speed collation of a streaked image, specifically a fingerprint. Again, as in some of the patents discussed above, there is no teaching of the assembled panoramic image for comparison.

In U.S. Pat. No. 5,379,106 issued to Roman Baldur on Jan. 3, 1995 there is disclosed a method and apparatus for positioning an article under optical observation. The apparatus uses lasers for the determination of the article's position. This is unlike the present invention in that there is no teaching of the computer controlled stepping motors or the smooth movement of the images in relation to one another when comparing them as is seen in the instant invention.

Another patent issued to Roman Baldur is U.S. Pat. No. 5,390,108, dated Feb. 14, 1995. This is a machine for automated bullet analysis. Unlike the present invention, it compares the stored image data an a segment by segment basis.

U.S. Pat. No. 5,544,254 issued to Richard I. Hartley et al. on Aug. 6, 1996 discloses an apparatus and method for classifying and sorting objects, such as synthetic diamonds. An image taken at an angle is used for comparison with a variety of templates. This is clearly dissimilar from the instant invention.

Next is U.S. Pat. No. 5,654,801 issued on Aug. 5, 1997 to the same Roman Baldur as in the '108 and the '106 patents above. This is also dissimilar from the instant invention as no comparison of disparate images is taught in the process of correlation and comparison.

In U.S. Pat. No. 5,857,202 issued to Franck Demoly et al. on Jan. 5, 1999 there is disclosed a process for comparing projectile shells. As in many of the patents discussed above, there is no teaching of moving a pair of images in relation to one another to visually determine the closeness of the match.

A system for comparing digital images is disclosed in U.S. Pat. No. 5,907,641 issued to Marco Corvi et al. on May 25, 1999. This is also clearly dissimilar from the instant invention in that the computer controlled stepping motor for successively rotating the bullet is not seen.

U.S. Pat. No. 6,018,394 issued to Roman Baldur on Jan. 25, 2000 discloses an apparatus and method for comparing fired ammunition. No comparing of a pair of images on a side by side basis is taught.

Next is U.S. Pat. No. 6,097,833 issued to Steven Lobregt et al. on Aug. 1, 2000. This is another patent clearly unlike the present invention in that no stepping acquisition to assemble the final image is taught.

U.S. Pat. No. 6,125,192 issued on Sep. 26, 2000 to Vance C. Bjorn et al. discloses a fingerprint recognition system. Again, no teaching of the stepped image acquisition is seen.

Lastly, in U.S. Pat. No. 6,185,311 issued to Vladislov Yanovsky et al. there is seen a key imaging system. This compares stored images, as in many of the other patents above, but, again, it fails to teach the instant invention's image acquisition and processing.

Thus, while the foregoing overview of prior art indicates it to be well known to provide various systems and apparatus for comparing stored, digitized images one to the other, none of the inventions discussed above, either alone or in combination, describe the instant invention as claimed.

### SUMMARY OF THE INVENTION

To achieve the foregoing and other advantages, the present invention, briefly described, provides a forensic microscopy system wherein a plurality of panoramic views of the sides of a spent bullet or casing may be stored in a computer. To compare one of these stored images with a sample bullet or casing, a computer controlled stepping motor rotates the sample approximately five degrees and an image is taken and stored at each stop. After the full 360 degrees has been accumulated, the images are formed together to create a single whole picture of the entire circumferential surface of the sample. This panoramic strip is then split longitudinally into two halves. The same is done with the stored sample and the “right side” and “left side” of both the strips are matched with their opposite side of the corresponding sample. The software in the computer then allows the user to compare the pattern of lands and grooves on the sample with another stored sample pattern by putting the two images side by side and allowing the user to move one of them in relation to the other. Bullets fired from the same weapon are easily and quickly matched visually. Additionally, the sample bullet or casing can be compared sequentially with any number of other stored sample images.

Thus it is a principal object of the invention to provide a forensic microscopy system that allows the user to visually compare the entire exterior of a spent bullet or casing to another.

It is a further object of the invention to provide a forensic microscopy system wherein a computer controls the stepper motor used to acquire the sequence of images that make up the panoramic image of either the bullet or the bullet casing exterior.

Still yet a further object of the invention is to provide a forensic microscopy system wherein the images to be compared are displayed side by side and one is movable in relation to the other so that similar markings on the exterior can be compared visually.

Still yet another object of the invention is that the panoramic image that is developed may be split longitudinally to form a “left” half and a “right” half of the image and that these halves are paired with their opposite during the comparison process

Yet another object of the invention is to provide a forensic microscopy system wherein the bullet or casing to be sampled is rotated in steps of five degrees or so (depending on the magnification desired) to acquire an extremely detailed resulting image.

Still yet another object of the invention is to provide a forensic microscopy system wherein the computer that controls the motor, image storage and comparison display is a standard personal computer.

And still yet another object of the invention is to provide a forensic microscopy system wherein the magnification used for the comparison is variable.

These together with still other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

The invention will be better understood and the above objects as well as objects other than those set forth above will become more apparent after a study of the following detailed description thereof. Such description makes reference to the annexed drawings wherein:

FIG. 1 is a perspective view of the microscope, the lighting system, sample mount, and the PC controller.

FIG. 2 is a side view of the stepper motor and a sample showing the sequential rotation of the sample in 5 degree increments.

FIG. 3 is a sample view of the images created by the apparatus of a pair of bullet samples and then one of the compound images then used for comparison.

FIG. 4 is a schematic view of the paired left and right halves of the corresponding strips and a demonstration of how, when the user moves one of the halves of the strip, the opposite side of the strip moves simultaneously to allow the user to more quickly determine whether a match exists.

### DESCRIPTION OF THE PREFERRED EMBODIMENT

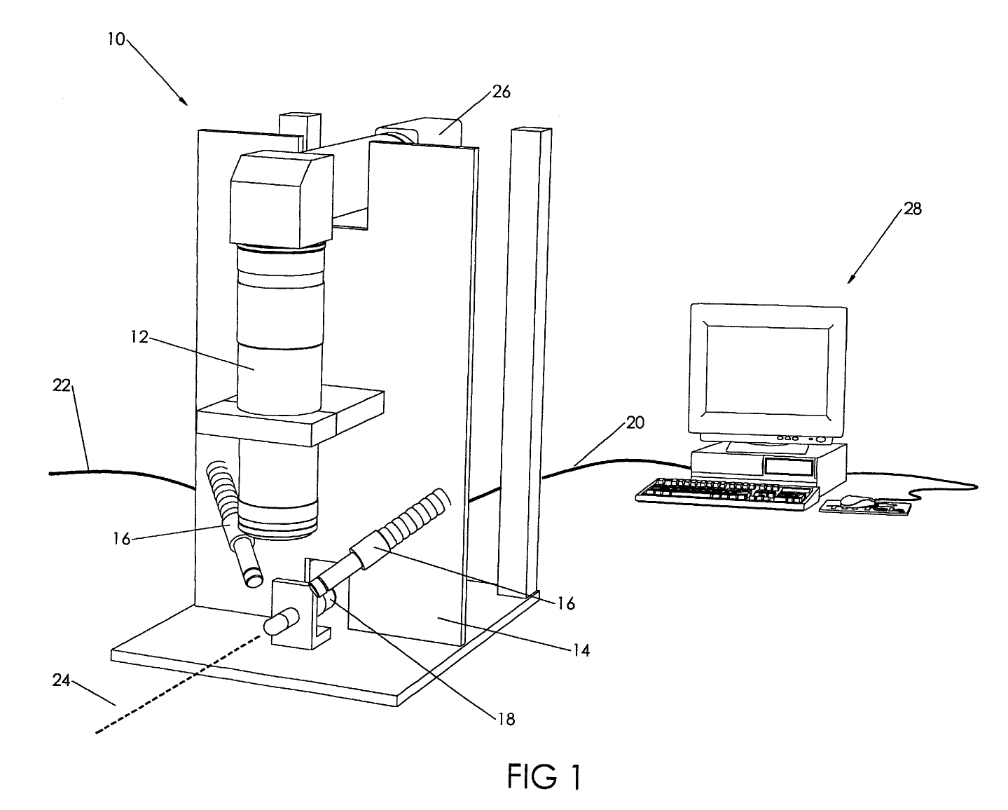

Turning now to FIG. 1, the various elements which make up the apparatus will be described. The mechanical apparatus is generally indicated at 10. It comprises the microscope itself 12, mounted on the base 14, the lighting units 16, the stepper motor indicated at 18, the cable 20 connecting the computer (discussed in further detail below) to the apparatus 10, and the power cable 22. Indicated at 26 is the camera that transmits the image magnified by the microscope 12 to the computer.

The microscope 12 is a video zoom microscope with an assortment of lenses that will allow the user to collect and image between 5× and 1000×, depending on the sample to be compared. The base 14 is preferably made from aluminum anodized black. The lighting units 16 are preferably 150 watt fiber optic light sources, providing 3200 degree K color temperature, and both include a manually controlled dimmer (not shown). It should be understood, though, that the dimmer could be controlled by the computer. The stepper motor 18 is capable of 360 degree rotation about the axis indicated 24 in FIG. 1. The cable 20 connecting the computer to the motor 18 and the camera 26 is a standard 9-wire shielded cable. In the preferred embodiment the camera 26 itself is a color camera with S-video output. It has a ½″ image sensor, 768 (horizontal) by 494 (vertical) pixels, has a 8.4 μm (h) by 9.8 μm (v) cell size, and has 450 lines of horizontal resolution. It should be understood, though, that other types of cameras would work equally well. A black and white camera, for example, could be used.

In the preferred embodiment described herein, the computer, indicated generally at 28 is a Pentium™ III 800 mhz carrying 128 MB of 133 mhz RAM with a 20 GB hard drive. Also, in this embodiment, the machine runs in the Microsoft™ Windows environment and the system includes a 17″ color monitor. It should be emphasized that the type of computer or the operating system that controls it form no part of the instant invention.

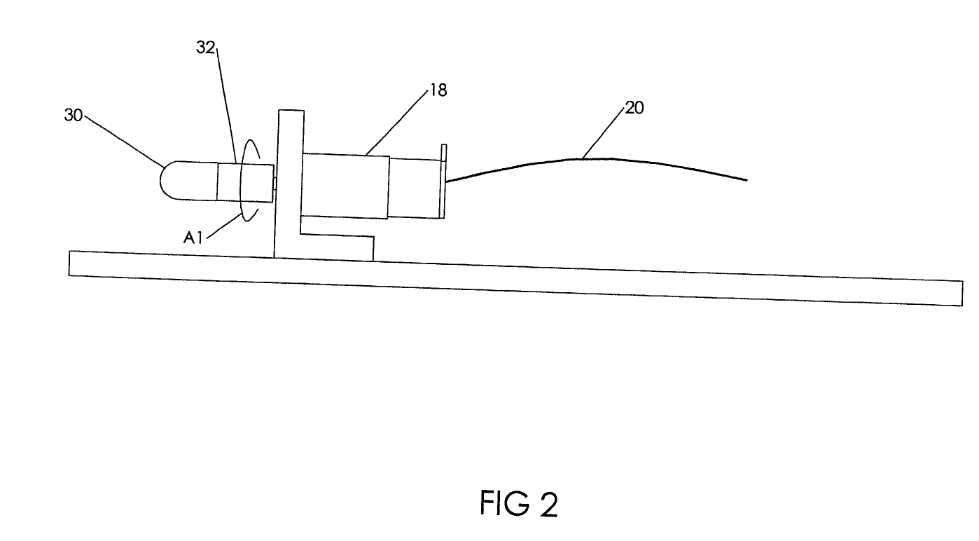

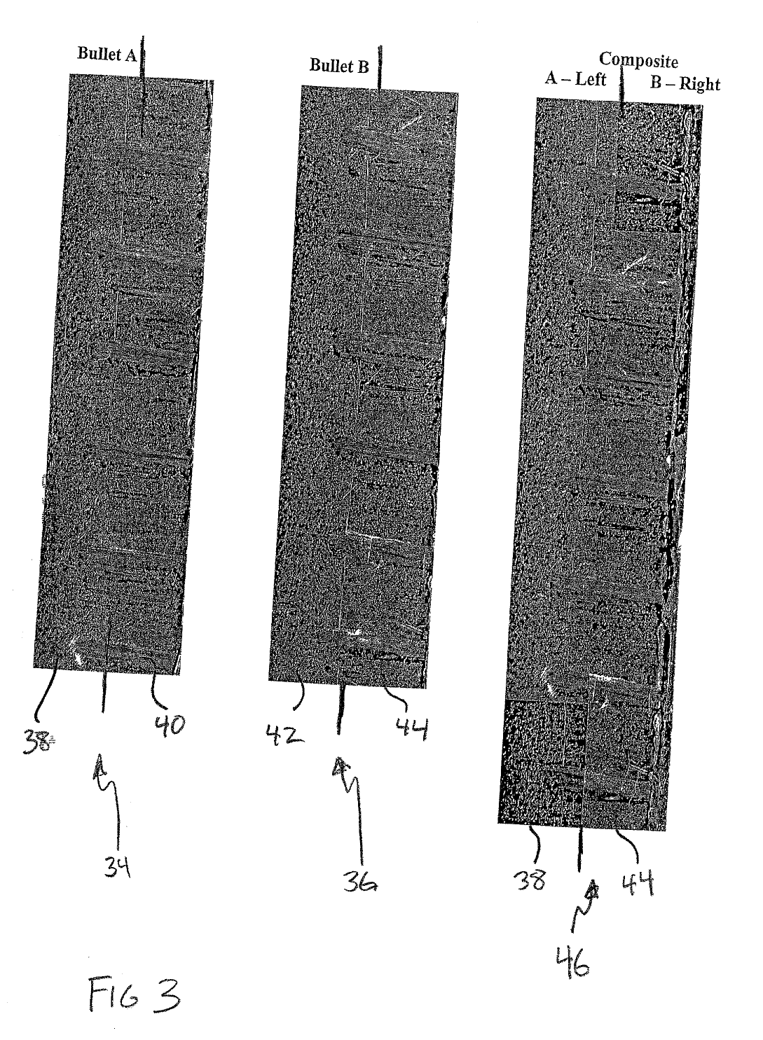

Turning now first to FIG. 2, the operation of the apparatus will be described. The sample, indicated at 30 is attached to the sample holder 32. The user focuses the microscope at the magnifying power that is needed and adjusts the lighting to their satisfaction. The first image of the sample 30, is then taken and stored digitally. The stepper motor 18 then rotates the sample 30 through, in the preferred embodiment, 5 degrees as is indicated by the arrow A1. It makes no difference to the operation of the invention whether or not this rotation takes place in a clockwise or counterclockwise direction. This sequence is repeated 72 times and the entire circumferential surface of the sample 30 can then be reproduced in a strip, such as is seen in FIG. 3 indicated at 34 and 36. Because each “slice” is so small, 1/72nd of the total of the circumference, when the computer presents them all together, an apparently seamless whole is perceived.

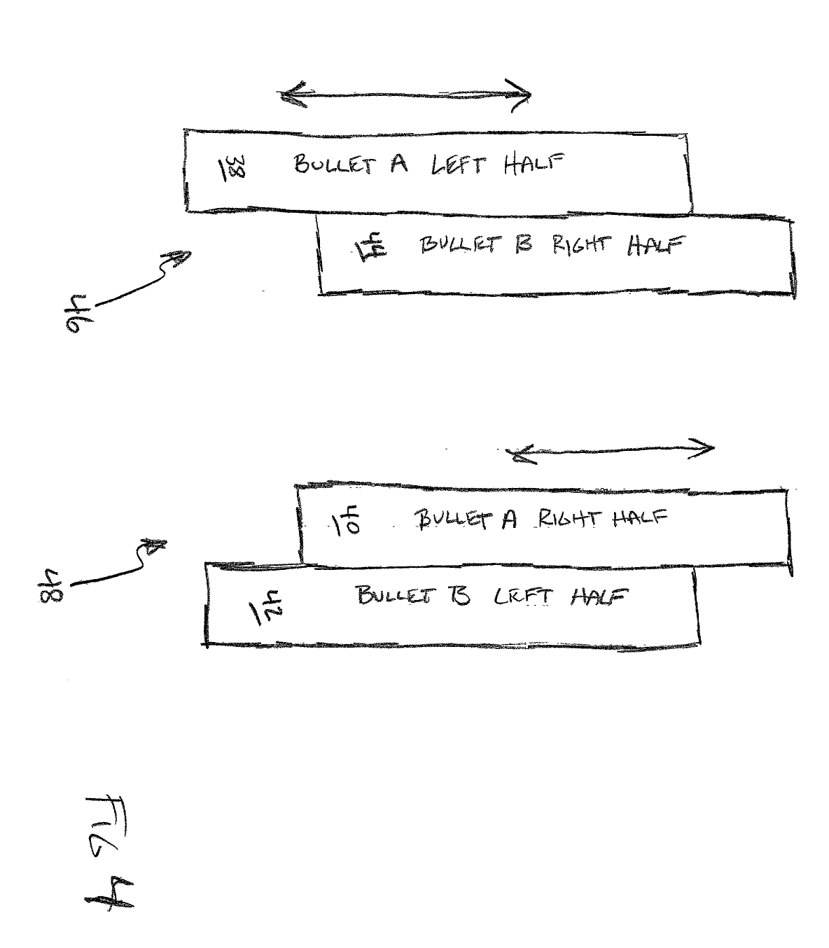

Now we turn to FIG. 3. These are reproductions of actual images taken of two separate 0.380 caliber bullets fired from the same weapon, through the same barrel. Bullet A is indicated at 34 and Bullet B is indicated at 36. These separate images are then split down the middle to form a “right side” portion and a “left side” portion. A composite, or a pair of composites is then made. These composites are indicated at 46 and 48 (seen together in FIG. 4). In the preferred embodiment two composites are made in the interest of speed, but it should be understood that only one would work just as well. Note that the right and left sides of Bullet A are paired with the opposite side of Bullet B. Turning to FIG. 4, note that the left half of each composite is movable on the computer screen by means of the mouse or the keyboard. Both of these left halves slide simultaneously. The image data from the right or left sides may be wrapped on to the other end to facilitate the comparison. For example, the two darkened areas indicated at 50 and 52 in FIG. 3 are such “wrapped over” areas.

By using the apparatus in a way such as described, many stored samples can be compared to the sample in question with less eyestrain and fatigue. Additionally, the invention allows for a database of stored samples from a plurality of firearms to be created, thus allowing every gun sold in a certain locality after a certain date to be fired and the both the casing and the bullet can be digitally stored with the appropriate information: the buyer's name, address, telephone number, etc.

It should be emphasized that the instant invention is not in any way limited to the embodiments as they are described above but encompasses all embodiments as described in the scope of the following claims.

What is claimed as being new and desired to be protected by Letters Patent of the United States is as follows:

1. An apparatus for storing and comparing the surface marking characteristics of spent sample bullets and sample shell casings comprising:
a sample retaining means, said sample retaining means forming an axis of sample rotation, said retaining means further including a motor to rotate the sample a predetermined angular distance;
a microscope, said microscope being disposed such that the field of view of said microscope is perpendicular to said axis of sample rotation;
lighting means for lighting the sample;
camera means for recording a plurality of sequential sample images at predetermined intervals;
a control and storage means for controlling said motor and determining said predetermined rotation distance and for storing said plurality of said sample images and for determining said predetermined intervals;
an image consolidation means for consolidating said plurality of said sample images such that said sample images are formed into a panoramic strip of the exterior of the sample, said image consolidation means further being part of said control and storage means such that said consolidated panoramic strip may be stored; and
a visual display means for displaying any pair of said stored panoramic strips such that a visual comparison can be made by a user of the surface marking characteristics of two separate samples.

2. The apparatus according to claim 1, wherein said panoramic strips are divided into two halves longitudinally by said image consolidation means and each one of said halves of one of said pair is displayed immediately next to the opposite said half of the other said panoramic strip being compared.

3. The apparatus according to claim 2 wherein one of said halves of said panoramic strips being compared is movable in relation to said opposite half.

4. The apparatus according to claim 1, wherein said predetermined angular distance of said sample rotation is five degrees.

5. The apparatus according to claim 4, wherein said predetermined interval is the time it takes to rotate the sample said five degrees.

6. The apparatus according to claim 5, wherein said panoramic strips are divided into two halves longitudinally by said image consolidation means and each one of said halves of one of said pair is displayed immediately next to the opposite said half of the other said panoramic strip being compared.

7. The apparatus according to claim 6 wherein one of said halves of said panoramic strips being compared is movable in relation to said opposite half.

8. A method of storing and comparing the surface marking characteristics of spent sample bullets and sample shell casings comprising the steps of:
mounting the sample on a retaining means having an axis of sample rotation;
acquiring a magnified image of a portion of the exterior of the sample;
storing said magnified image in a digital format;
rotating the sample a predetermined angular distance;
repeating said image acquiring step and said storing step until the entire circumferential outer surface of the sample has been stored in the digital format;
consolidating said stored images into a panoramic strip representing a magnified view of the entire circumferential outer surface of the sample;
displaying a pair of said panoramic strips such that a visual comparison can be made between the surface marking characteristics of the samples.

9. The method according to claim 8, wherein said predetermined angular distance is five degrees.

10. The method according to claim 8, further including a step between said consolidating step and said displaying step comprising:
dividing each said panoramic strip longitudinally to form two halves and pairing each said half with an opposite said half of the other of the said pair of panoramic strips for visual comparison.

11. The method according to claim 10, wherein said predetermined angular distance is five degrees.
